(19) United States
(12) Patent Application Publication
(10) Pub. No.: US 2008/0061482 A1
(43) Pub. Date: Mar. 13, 2008

(54) CUTTING TORCH WITH ELECTRIC INTERNAL IGNITION DEVICE

(75) Inventors: Josef Faust, Erbach (DE); Hans-Joachim Albert, Hofheim (DE)

Correspondence Address: TIAJOLOFF & KELLY, CHRYSLER BUILDING, 37TH FLOOR, 405 LEXINGTON AVENUE, NEW YORK, NY, 10174, US

(73) Assignee: MESSER CUTTING & WELDING GMBH, Gross-Umstadt (DE)

(21) Appl. No.: 11/854,253

(22) Filed: Sep. 12, 2007

(30) Foreign Application Priority Data
Sep. 13, 2006 (DE) DE 102006043727.6

(51) Int. Cl. F23D 14/42; F02P 3/01; H01F 38/24

(52) U.S. Cl. 266/48; 323/359; 431/258

(57) ABSTRACT

The cutting torch according to the invention is provided with an electric internal ignition device (3) and comprises a high-voltage source (19) arranged inside the cutting torch. The high-voltage source (19) contains a high-voltage transformer (4) with a rod-shaped ferrite core and an electronic controller (5) comprising a Meissner oscillator (20).

The present invention relates to a cutting torch, preferably a machine cutting torch, comprising an electric internal ignition device connected to a high-voltage source,

Furthermore, the present invention relates to a high-voltage source suited for the cutting torch

DE 35 27 955 C2 describes a cutting torch with internally arranged ignition device, the ignition device representing an ignition plug arranged inside the cutting torch body, or an ignition electrode, which is also called “internal ignition device”. Said internal ignition device is connected via a so-called ignition cable to an ignition transformer arranged outside the cutting torch, as the high-voltage source

A machine cutting torch with internal ignition is also described in DE 41 43 144 C2. In this instance, too, an internally located electric ignition device, preferably a glow plug, is used.

The known cutting torches with internally located electric ignition device are distinguished by a voltage source arranged outside the cutting torch, the voltage source requiring various additional parts outside the cutting torch. The cable connecting the voltage source to the cutting torch must be protected against thermal and mechanical damage and constitutes a safety risk because of the voltage. Moreover, the long voltage cable causes EMC disturbances.

It is the object of the present invention to provide an improved cutting torch, particularly machine cutting torch, which overcomes said drawbacks.

Moreover, it is the object of the present invention to indicate a high-voltage source suited therefor, which requires little space and shows high temperature stability

As for the cutting torch, this object, starting from a cutting torch of the above-mentioned type, is achieved according to the invention in that the voltage source is configured as a high-voltage source arranged inside the cutting torch

In the cutting torch according to the invention, it is not only the electric internal ignition device, but also the high-voltage source that is arranged inside the cutting torch. As an alternative, but less preferred, the high-voltage source may also be provided directly on the cutting torch in direct communication with said torch.

At any rate the cutting torch with the internally located electric ignition device comprises a high-voltage source in direct vicinity of the guide tube of the cutting torch. Preferably, the high-voltage source is arranged inside the cutting torch, particularly in a cavity inside the guide tube of the cutting tube, or (less preferred) in direct spatial communication on the cutting torch, for instance as a component mounted or attached onto the cutting torch. Such an arrangement of the high-voltage source does not require a high-voltage cable for connection to the internal ignition device or other high-voltage parts in the area outside the cutting torch.

The cutting torch is a hand-operated cutting torch or, preferably, a machine cutting torch The machine cutting torch is part of a torch cutting machine.

The combination consisting of the internal ignition device (for instance an ignition electrode) and the high-voltage source (ignition device) is here designated as ignition unit. The ignition unit contains ignition device and high-voltage source preferably as independent parts

As a rule, the high-voltage source comprises an ignition transformer (high-voltage transformer) and an electronic control unit.

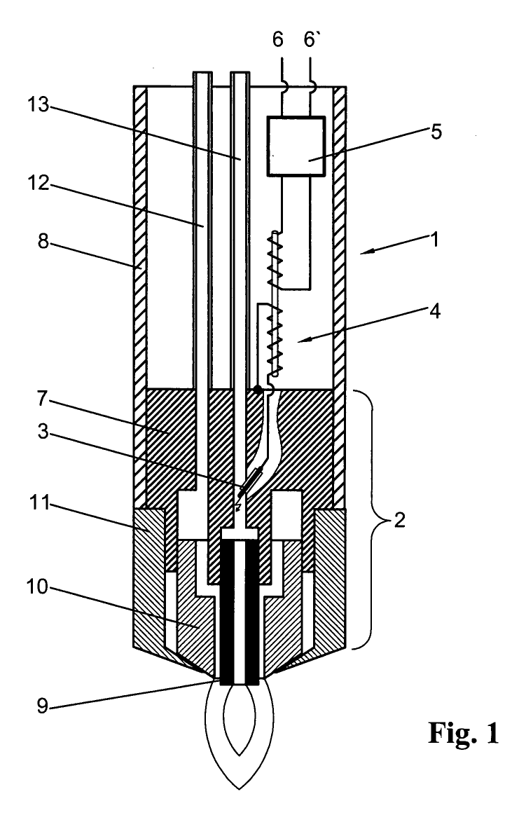

The cutting torch comprises a torch head or torch body and, as a rule, a tubular section serving as a housing part. Such a cutting torch is e.g described in DE 35 27 955 C2, there particularly in FIG. 1, which is herewith referred to. In this cutting torch, the tubular section is designed as a guide tube between torch head and valve body

Also in the case of the cutting torch according to the invention, the tubular section (guide tube) comprises a cavity. The high-voltage source, also called ignition apparatus, is preferably arranged in this cavity.

Advantageously, the high-voltage source (ignition device) is configured as a modular component the size of which permits installation in said cavity.

Preferably, the high-voltage source is arranged near the ignition electrode. As a rule, the distance of the high-voltage source, particularly of the high-voltage or ignition transformer, from the ignition device, particularly the ignition electrode, ranges from 0.1 to 20 cm, preferably from 0.1 to 15 cm, particularly preferably from 0.1 to 10 cm, particularly from 0 1 to 5 cm. Hence, the high voltage line, e.g. a high-voltage cable, normally shows a corresponding length from the output of the high-voltage source to the input of the ignition electrode.

The core of the ignition transformer is preferably made straight, i.e. rod-shaped. The rod-shaped ignition transformer core advantageously consists of ferrite.

As a rule, the high-voltage source generates a high voltage of several thousand volts from a supply voltage, normally a d c or a c voltage of low voltage. The supply voltage is in general a voltage below 100 V, for instance in the range of 10 to 50 V, particularly in the range of 10 to 30 V, typically 24 V The supply voltage is preferably a d.c. voltage, particularly preferably a d.c. voltage of 24 V. The high voltage produced is in general within the range of 5000 to 25000 V, particularly in the range of 10000 to 20000 V. The high voltage supplied to the ignition device is normally a high-frequency a.c. voltage.

The arrangement of the whole ignition unit, i.e. ignition device and high-voltage source, in the interior of the cutting torch offers many advantages For instance, the operational safety of the cutting torch is much higher than in conventional cutting torches. All of the high-voltage parts and lines are located in the interior of the cutting torch and protected from damage or manipulation. This causes less EMC disturbances because all of the high-voltage parts and lines are shielded by the metallic outer wall, particularly the guide tube, of the cutting torch. There is even a dual protection of high-voltage transformer and electronic components due to a separate housing of the high-voltage source. Furthermore, the former external attachment parts and the former wiring efforts are not required any more. Moreover, the risk of accident is reduced. Due to the compact and size-fitted construction, conventional cutting torches can be retrofitted without great efforts.

As for the high-voltage source, the above-indicated object is achieved according to the invention in that it is configured with a high-voltage transformer having a rod-shaped core

Standard external high-voltage sources are not suited for use in or on a cutting torch, particularly for installation into a cutting torch, for these are too large and are also not able to satisfy the thermal demands. Moreover, they also lack the power density required for installation in a cutting torch.

The high-voltage source according to the invention contains a high-voltage or ignition transformer made from a thermally resistant material, said transformer being rod-shaped so that the space needed is comparatively small.

Appropriate, thermally resistant plastics are e.g. modified polyesterimides, polyamidimides or aromatic polyimides. The core of the ignition transformer is straight, i.e. rod-shaped.

The ignition transformer, just like the whole high-voltage source and the other components contained therein normally show a temperature resistance (heat resistance) of at least 150° C., preferably of at least 180° C., particularly preferably of at least 200° C. In this respect they clearly differ from the conventional technique used in cutting torches.

The temperature resistance of the ignition transformer is achieved through a temperature-resistant coil body for the transformer coils and a temperature-resistant insulation of the transformer windings and the cables. The coil bodies are e.g. made from a ceramic material or a temperature-resistant plastic material, preferably from a temperature-resistant thermoplastic material, for instance polyetheretherketone (PEEK).

An enameled copper wire with temperature-resistant insulation is preferably used for the transformer windings. The insulation layer of the enameled copper wire advantageously consists of a thermally resistant plastic material, which is preferably resistant at a temperature ranging from 200° C. to 250° C.

The preferred ignition transformer is a high-voltage transformer with a rod-shaped ferrite core. A rod-shaped ferrite core is an open magnetic circuit and is normally not used for transformers or transducers. A rod-shaped ferrite core, however, is particularly advantageous for installation into a cutting torch. Soft-magnetic oxide-ceramic ferrite materials with a base material MnZn are suited for producing a high power density Preferred is a straight ferrite core consisting of an MnZn base material. A highly suited ferrite material is e.g. available under the name SIFERRIT N92 (manufacturer EPCOS AG).

A high-frequency voltage, for instance in the frequency range of 20 to 25 kHz, is usually supplied to the ignition transformer. This high-frequency voltage is preferably generated from a d.c. voltage in the low-voltage range, for instance a d. c. voltage of 24 V, in an electronic unit. This electronic unit is called controller. The components used in the controller, particularly the electronic components, are also heat-resistant.

For control purposes, use is advantageously made of an electronic circuit which is a self-inducing oscillator. This type of circuit is also known as Meissner oscillator and can be operated with a small number of components. The components needed for it are available in a heat-resistant configuration, which is not the case with all electronic components.

As a rule, the high-voltage source has a volume of less than 100 cm³, preferably a volume of less than 80 cm³, particularly preferably a volume of less than 75 cm³, the volume preferably representing the volume of a cylindrical space. As a rule, the cylindrical space has a length of less than 25 cm, preferably a length of less than 15 cm, particularly preferably a length of less than 10 cm, or less As a rule, the cylindrical space has a diameter of less than 5 cm, preferably a diameter of less than 2 5 cm, particularly preferably a diameter of less than 1.5 cm, or less The high-voltage source occupies, for instance, a cylindrical space of less than 100 cm³, preferably less than 80 cm³, and it has a length of less than 25 cm, preferably less than 20, 15, 10, 8 or 6 cm

As a rule, the high-voltage source is arranged in a separate housing. The housing is preferably cylindrical. As a rule, the cylindrical housing has a length of less than 25 cm, preferably less than 20, 15, 10, 8 or 6 cm, and a diameter of less than 5 cm, preferably less than 4, 3, 2 or 1 cm

The high-voltage source supplies, for instance, an output current of not more than 10 mA, preferably not more than 5 mA, particularly preferably not more than 3 mA.

The high-voltage source has, for instance, a power of not more than 1000 mJ, preferably of not more than 500 mJ, particularly preferably of not more than 350 mJ.

Advantageously, the high-voltage source is fed with a d.c, voltage of 24 V, which is normally applied in the case of industrial machinery.

Advantageously, a material or a device for thermal insulation and/or for electrical insulation is arranged in the cutting torch between guide tube and high-voltage source. This can e.g. be accomplished by using a housing for the high-voltage source, the housing comprising an insulating layer

The high-voltage source according to the invention is distinguished by the small space required by it and by its high temperature stability, so that an installation in conventional cutting torches is also possible without any special adaptation.

The invention shall now be explained with reference to the drawing, in which:

FIG. 1 is a schematic sectional view of the lower part of a cutting torch according to the invention with the ignition unit;

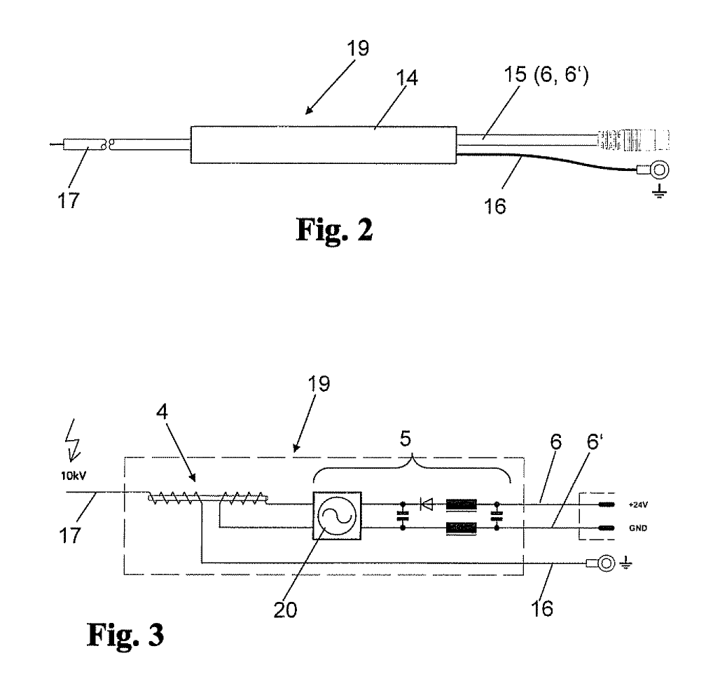

FIG. 2 is a schematic view of a high-voltage source according to the invention as a structural unit, and

FIG. 3 is a schematic view of the configuration of a high-voltage source according to the invention in a structural unit.

FIG. 1 shows, in cross section, the lower part of a cutting torch 1 according to the invention, more exactly a machine cutting torch, by way of example, the cutting torch comprising a torch head 2 and a guide tube 8 through which the torch head 2 is connected to the valve body (not shown in FIG. 1)

The torch head 2 contains the torch cutting nozzle 9, the heating nozzle 10 and the holding cap 11 The torch head 2 is supplied via channel 12 with a combustion gas mixture and via channel 13 with a cutting oxygen gas.

The torch body 7 of the torch head 2 has arranged therein the ignition device 3 (ignition plug or ignition electrode) which is electrically connected to the ignition transformer 4.

The ignition transformer (high-voltage transformer) 4 is electrically connected to the electronic unit 5 which is called controller and which supplies the ignition transformer 4 with a c. voltage. Ignition transformer 4 and controller 5 form the high-voltage source.

The high-voltage source is advantageously surrounded by a housing of its own (not shown in FIG. 1), which housing consists of a non-metallic material. Ignition device 3 and high-voltage source form the ignition apparatus The high-voltage source, particularly the controller 5, is supplied via lines 6, 6′ with the supply voltage, here a d.c voltage of 24 V.

FIG. 2 schematically shows an embodiment of a high-voltage source according to the invention as a modular unit. High-voltage transformer 4 and controller 5 (not shown) are installed in housing 14. The module of the high-voltage source further comprises a cable 15 with plug, a grounding cable 16 and an output cable 17. The cable 1s contains lines 6, 6′ (see FIG. 1) and serves to feed supply voltage The output cable 17 is connected to the ignition device 3 (see FIG. 1). The output cable 17 has, for instance, a length of about 10 cm. The cable 15 has, for instance, a length of about 8 cm. The housing 14 is cylindrical and has, for instance, a length of 10 cm and a diameter of 1.4 cm The housing 14 is preferably made from an electrically insulating material

FIG. 3 shows the preferred embodiment of the high-voltage source 19. The controller 5 is fed by lines 6, 6′ with a d c. voltage of 24 V as the supply voltage An output voltage of 10 kV is supplied at the output 17. The output current is not more than 3 mA. The power of the high-voltage source 19 is not more than 350 mJ. The high-voltage source 19 contains the ignition transformer (high-voltage transformer) 4 and the electronic unit 5 (controller).

The controller 5 contains a so-called Meissner oscillator 20 in the electronic circuit. This type of circuit permits a configuration of the controller with few electronic components, which are moreover available as heat-resistant types

The ignition transformer (high-voltage transformer) 4 comprises a rod-shaped core as a special feature, said core consisting of ferrite material (base material MnZn). The special shape of the transformer core and the special material permit a lean construction of a high power density. An enameled copper wire with a heat-resistant insulation layer is used for the transformer windings. The insulation layer is preferably made from a thermally stable plastic material, such as modified poylesterimide, polyamidimide, or aromatic polyimide. Such plastic materials are stable at 200° C. The transformer coil bodies are preferably made from a thermally stable plastic material such as polyetheretherketone (PEEK). The high-voltage source 19 is advantageously configured as a module in FIG. 2

1. A cutting torch comprising: an electric internal ignition device connected to a voltage source wherein the voltage source is s a high-voltage source supported inside the cutting torch.

2. The cutting torch according to claim 1, wherein the high-voltage source has a housing made from a non-metallic material.

3. The cutting torch according to claim 1, wherein the high-voltage source is supported in a cylindrical housing having a length of less than 15 cm and a diameter of less than 2.5 cm or in a housing having a volume of less than 100 cubic centimeters.

4. The cutting torch according to claim 1, wherein the high-voltage source is supported in an area of a guide tube or a shaft inside the cutting torch.

5. The cutting torch according to claim 1, wherein the cutting torch has no external high-voltage parts.

6. The cutting torch according to claim 1, wherein the high-voltage source has a volume of less than 100 cm³ or is cylindrical with a length of less than 15 cm or is cylindrical with a diameter of less than 2.5 cm.

7. The cutting torch according to claim 1, wherein a material or a device for thermal insulation and/or electrical insulation is arranged between a guide tube and the high-voltage source.

8. The cutting torch according to claim 1, wherein the high-voltage source is an interchangeable module.

9. The cutting torch according to claim 1, wherein the high-voltage source is a high-voltage source having a high-voltage transformer with a rod-shaped core.

10. A high voltage source for electrically ignited cutting torches, said high voltage source having a high-voltage transformer with a rod-shaped core.

11. The high-voltage source according to claim 10, wherein core of the high-voltage transformer is of a ferrite material.

12. The high-voltage source according to claim 10, wherein the high-voltage transformer comprises a ferrite core, which contains manganese and zinc as a base material.

13. The high-voltage source according to claim 10, wherein the high-voltage transformer has a cylindrical shape.

14. The high-voltage source according to claim 10, wherein the high-voltage source is heat-resistant.

15. The high-voltage source according to claim 10, wherein high-voltage transformer comprises a heat-resistant coil body and transformer windings made of a wire with a heat-resistant insulation layer.

16. The high-voltage source according to claim 10, wherein the high-voltage source contains a heat-resistant electronic unit which comprises an input for a d.c. voltage current and an output for a high-frequency a.c. voltage current.

17. The high-voltage source according to claim 10, wherein high-voltage source contains a heat-resistant electronic unit containing a Meissner oscillator.

18. The high-voltage source according to claim 10, wherein the high-voltage source contains a heat-resistant electronic unit that is positioned upstream from the high-voltage transformer.

19. The high-voltage source according to claim 10, wherein the high-voltage source comprises a housing containing thermal insulation or a thermal insulation layer.

20. The torch of claim 1, wherein said torch is a machine cutting torch.
